(19) United States
(12) Patent Application Publication
(10) Pub. No.: US 2007/0144560 A1
(43) Pub. Date: Jun. 28, 2007

(54) Cleaning apparatus and method of circuit boards in advanced electronic devices by making use of insulating liquids

(76) Inventor: Han Sup Uhm, Potomac, MD (US)

Correspondence Address: Han Sup Uhm, 11613 Swains Lock Terrace, Potomac, MD, 20854, US

(21) Appl. No.: 11/316,749

(22) Filed: Dec. 27, 2005

(51) Int. Cl. B08B 7/04; B08B 3/00; B08B 3/04

(52) U.S. Cl. 134/34; 134/10; 134/104.2; 134/198

(57) ABSTRACT

The present invention relates to a cleaning apparatus and method of circuit boards by making use of insulating liquids and, more particularly, to the cleaning apparatus of live circuit-boards in advanced electronic and communication devices, while the power is on, by specially prepared cleaning liquid. The invention provides a safe eliminating method of micro dust particles from sensitive circuit boards. The apparatus includes a can filled with specially prepared cleaning liquid, a spray device attached to the aforementioned can, and an adsorption pad placed under the aforementioned circuit boards in the advanced electronic and communication devices. The aforementioned spray device sprays the specially prepared cleaning liquid over the circuit board with the spraying pressure of 5 kgf/cm² or more. The specially prepared cleaning liquid collects micro dust particles on the circuit boards while it runs down the surface of the circuit board. The adsorption pad adsorbs the cleaning liquid that captures the dust particles and mingles with the dust, falling down from the circuit board.

### FIELD OF THE INVENTION

The present invention relates generally to the cleaning apparatus and method of circuit boards by making use of insulating liquids and more particularly to the cleaning apparatus of live circuit-boards in advanced electronic and communication devices, while the power is on, by specially prepared cleaning liquid, eliminating micro dust particles from the circuit boards.

### BACKGROUND OF THE INVENTION

High tech devices in the information and communication area for example need high speed and reliable performance, hence requiring a clean environment within the circuit system. The present circuit boards consist of sensitive electronic parts. Micro dust particles often cause malfunction, performance deterioration, and shortening of circuit lifetime, leading to a fatal failure of the system with safety problems and economic loss.

The most electric components installed in electronic and communication devices are charged bodies in general, displaying electric properties. Small airborne particles, like dusts, are polarized as they approach a charged body and therefore attach to electric parts in the electronic and communication devices due to the attractive force between the particles and the charged body, contaminating the devices.

Electronic products are miniaturized as the technology advances, leading to a system of micro-sized circuits. The micro dust particles accumulated on the micro-sized circuits in the circuit boards may cause critical technical problems, resulting in malfunctioning or operational failures in advanced electronic and communication devices. Dust particles are mostly made of silicon dioxide but, they also contain feldspar or iron molecules, which are conducting materials. The accumulated dust particles absorb moisture from air, containing water molecules between particles, thereby becoming conducting materials. The conducting material or water in the accumulated dust particles on the circuit boards may cause short-circuiting in the systems of the micro-sized circuits, creating various technical problems.

The accumulated dust even without the conducting materials may also cause other serious problems to the circuit boards due to an electric discharge. We will briefly study the electrostatics to investigate other negative influences of the dust particles on the electronic and communication devices. The electric potential V at surface of a charged sphere with charge Q and radius R is given by

$$V = \frac{Q}{4 {πɛ}_{0} R} \qquad ( 1 )$$

where ε₀ is the dielectric constant in vacuum. The electric field strength E at the surface of the sphere is also given by

$$E = \frac{Q}{4 {πɛ}_{0} {R}^{2}} . \qquad ( 2 )$$

The electric field strength E relates to the potential V by E=V/R from Eqs. (1) and (2). In other words, the electric field strength is inversely proportional to the radius R for a given electric potential. This means that a strong electric field forms at sharp points where the curvature radius is small.

The regions with the smaller radii of curvature have higher surface charge density, thereby having stronger electric fields. The electric field can cause an electric discharge in the air, if its strength is great enough (about 30 kV/cm for dry air). The breakdown occurs because there are usually some molecules in the air that have been ionized (that is, electrons have been detached) by cosmic rays from space or by natural radioactivity in the soil.

The electrons detached from the ions accelerate rapidly under the action of the electric field, colliding with other molecules, and thereby creating more ions and electrons. At this stage, the air loses its insulating properties and becomes a conductor. The result is a corona discharge that is accompanied by a visible glow.

To prevent corona discharge (an electric discharge), high-voltage equipments have smooth surfaces with the largest possible radius of curvature. For a given breakdown field strength, the electric potential V is proportional to R, i.e., V=ER from Eqs. (1) and (2). Therefore, the electric potential of a sphere with a radius of 10 cm may be raised to 300 kV before breakdown. On the other hand, a 0.05-mm dust particle can initiate an electric discharge at 150 V. Dust in grain silos or cement mills can easily become charged by friction and raised to this potential. The resulting electric discharges have led to several dust explosions in Canada and the United States. Obviously, the micro dust particles in the circuit boards may cause serious problems due to the electric discharge.

There are destructive and non-destructive failures due to the electric discharge in accumulated dust particles. A non-destructive failure, called the upset failure, caused by a mild electrical discharge may occur during the operation of systems, leading to instantaneous malfunctions or resulting to the loss of operational information of system. But the upset failure without hardware damage may be recovered by resetting the system or by the disappearance of the electric discharge. On the other hand, the destructive failure requires the hardware exchange. Remember that the malfunctions or failures of the system are directly related to the safety problems, for example, any failure in the function of elevators may cause serious safety problems.

The vacuum cleaner, air gun or brush has been conventionally used to eliminate dust particles from the circuit boards. The vacuum cleaner sucks in dust particles with air. But the remaining dust particles on the circuit board can be charged by the electrostatic charges generated by frictions between the circuit board and the passing air volume. The charged dust particles may produce a voltage difference between the electrical parts and the dust particles inducing an electric discharge and producing bad effects on the circuit boards. Next, the air compressor may be used to eliminate dust but it also has a chance to generate the electric discharge due to the air friction. The air compressor blows the dust particles off the circuit board inflicting physical harms on the person who works on cleaning because of harmful heavy metals in dusts. Dust particles, penetrated deep into the respiratory system, may cause asthma attacks. Dust particles also cause eye disease, allergic conjunctivitis, nasal inflammation, and skin diseases. Micro particles (with sizes less than 10 micrometers) penetrated into the lung cells may cause cancer. Finally, the brush can be used to eliminate dust from the board, but the brush may damage the mechanically sensitive circuits. Rubbing the brush on the circuit board is also a typical electric charging mechanism, inducing an electrostatic potential on the surface of the board and leading to the electric discharge.

In this context, new and innovative ideas of eliminating the accumulated dust particles from the circuit boards are desperately needed.

A few examples of the cleaning-required subjects are the printed circuit board (PCB) in advanced electronic traffic controllers, PCB in base transceiver systems in communication areas, PCB in instrumental panels of power plants (nuclear, hydraulic and thermal electric plants), military communication equipments (ATM exchanger, Microwave relay system, and TRS relay site), inverter and controller of automation circuits in elevators, broadcasting equipments, and production systems in semiconductor industries.

### SUMMARY OF THE INVENTION

In order to clean dust particles from the live circuit-boards in the advanced electronic and communication devices while the power is on, the present invention includes:

a can filled with specially prepared cleaning liquid that adheres micro dust particles and runs down the surface of the circuit boards;

a spray device that is attached to the aforementioned can and that sprays the specially prepared cleaning liquid over the circuit board with the spraying pressure of 5 kgf/cm² or more; and

an adsorption pad that is placed under the aforementioned circuit boards in advanced electronic and communication devices and that adsorbs the cleaning liquid mingled with micro dust particles, falling down from the circuit board.

And, in order to eliminate the dust particles from the live circuit-boards in the advanced electronic and communication devices while the power is on, the present invention includes:

a process of filling a can with specially prepared cleaning liquid with filling gas and attaching a spray device to the aforementioned can;

a process of spraying the specially prepared cleaning liquid on the circuit boards in the advanced electronic and communication devices; and

a process of absorbing cleaning liquid by the adsorption pad that quickly adsorbs the cleaning liquid mingled with the micro dust particles, falling down from the circuit board.

The first object of this invention is to provide the cleaning apparatus and method of live circuit-boards in advanced electronic and communication devices, while the power is on, by specially prepared cleaning liquid, and to eliminate micro dust particles from the circuit boards without making use of harmful chemicals.

The second object of the present invention is cleaning the circuit boards in advanced electronic and communication devices by specially prepared cleaning liquids that have appropriate physical and chemical properties so that the cleaning liquid prevents circuit shorting caused by water, contained in dust, during the cleaning process and prevents circuit damage caused by the electric discharge during the cleaning process.

The third object of the present invention is not to concentrate the electric flux lines at sharp points, made of micro dust particles, by spraying the specially prepared cleaning liquid which captures dust particles and mingles instantaneously, smoothing the surface without sharp points and to carry out the cleaning of the circuit boards in advanced electronic and communication devices without any electric discharge.

The fourth object of the present invention is to prevent any malfunction or failure of the advanced electronic and communication devices caused by the electric discharge and the circuit shorting, by eliminating the cleaning liquid mingled with dust particles from the circuit boards after the cleaning process.

Finally, the fifth object of the present invention is the elimination of accumulated dust particles on the circuit boards in the advanced electronic and communication devices with an appropriate cleaning liquid that cleans tiny circuits without inflicting any physical and chemical harm on the circuits.

### BRIEF DESCRIPTION OF DRAWING FIGURES

A more complete appreciation of the invention and many of its attendant advantages will be aided by reference to the following detailed description in connection with the accompanying drawings:

FIG. 1 is a schematic presentation of the cleaning apparatus of circuit boards in advanced electronic and communication devices by making use of insulating liquids in the present invention.

FIG. 2 is a block diagram illustrating the cleaning process of circuit boards in advanced electronic and communication devices by making use of insulating liquid in the present invention.

### DETAILED DESCRIPTION

The present invention is about an cleaning apparatus and method of circuit boards by making use of insulating liquids and, more particularly, to the cleaning apparatus of live circuit-boards in advanced electronic and communication devices, while the power is on, by a specially-prepared cleaning liquid. The present invention provides a near complete elimination of micro dust particles from circuit boards, thereby preventing any malfunction or failure of the advanced electronic and communication devices.

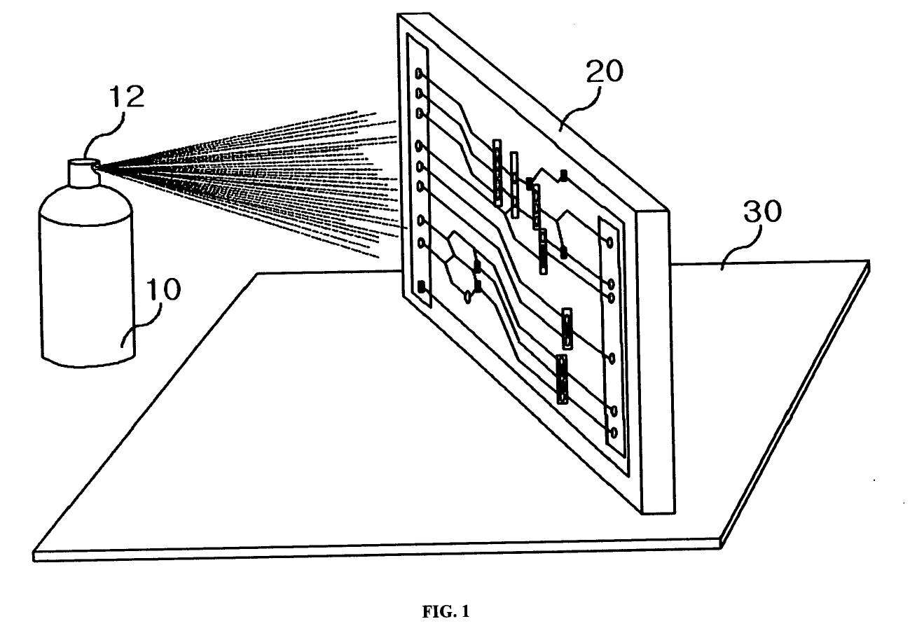

Referring now to the drawing in details, FIG. 1 is a schematic presentation of cleaning the apparatus of circuit boards in advanced electronic and communication devices by making use of an insulating liquid in the present invention. The basic portion of the present invention is a can 10 filled with specially prepared cleaning liquid with a filling gas, a spraying device 12 attached to the aforementioned can 10 and an adsorption pad 30 placed under the circuit board 20 in advanced electronic and communication devices. The aforementioned spray device sprays the specially prepared cleaning liquid over the circuit board 20 with the spraying pressure of 5 kgf/cm² or more. Here, 1 kgf is equivalent to 9.8 N. The specially prepared cleaning liquid collects micro dust particles on the circuit board 20, while it runs down the surface of the circuit board 20. The adsorption pad 30 adsorbs the cleaning liquid that captures micro dust particles and mingles with dust, falling down from the circuit board 20. The aforementioned filling gas is fluorinated hydrocarbon HCFC or HFC134a.

The aforementioned cleaning liquid must be an insulating liquid that has the maximum breakdown field strength in the range of 100˜200 kV/cm and has the total acid number less than 0.02 mgKOH/g. The electric discharge in air occurs at the electric field of 30 kV/cm and an explosive discharge occurs at 100 kV/cm or more. The aforementioned cleaning liquid must resist any kind of electrical breakdown even for high electric field. The total acid number indicates the acidity of the liquid. The high total acid number of the liquid may initiate an unwanted electrical breakdown. Therefore, the total acid-numbers less than 0.02 mgKOH/g are recommended.

The aforementioned cleaning liquid must have the ignition point higher than 65 degrees Celsius. The ignition point is an indicator of the possibility of a fire catching of the cleaning liquid.

The aforementioned cleaning liquid sprayed over the circuit board 20 will run down the surface of the board 20, evaporating into the air. The indicators of the evaporation speed of the cleaning liquid are the initial boiling point and the end point. The aforementioned cleaning liquid must have the initial boiling point in the range of 175˜195 degrees Celsius. The cleaning liquid with an appropriate value of the initial boiling point, after sprayed, must stay on the circuit board 20 with enough time to collect all the micro dust particles. The cleaning liquid cannot eliminate the dust particles if it evaporates too fast.

The aforementioned cleaning liquid is required to have the end point in the range of 200 ˜220 degrees Celsius. The cleaning liquid with proper initial boiling point sticks all the dust particles and falls down from the circuit board 20. However, there is some remaining cleaning liquid over the circuit board 20 after the cleaning. The leftover cleaning liquid must evaporate in appropriate time without causing any other source of contamination. The leftover cleaning liquid on the circuit board 20 may cause contamination if it stays there for an unnecessarily long time. The cleaning liquid, with the end point in the range of 200˜220 degrees Celsius, will ensure a fast evaporation of leftover liquid.

The aforementioned cleaning liquid captures the dust particles when sprayed over the circuit board 20. The surface tension of the cleaning liquid relates to the dust-collecting capability of the liquid. The cleaning liquid cannot capture the dust particle if it has a high surface tension; rather instead, it holds itself together. The water drops have a large contact angle when they are on a clean glass surface because of a large surface tension 73.5 dyne/cm² of water. Therefore, water is not a good dust capturing material. The aforementioned cleaning liquid must have the surface tension less than 30 dyne/cm² or less, thereby capturing the micro dust particles effectively.

The dust particles are accumulated on the circuit board 20 with organic molecules floating around the air. The properties of these organic molecules have similar properties of oils. The cleaning liquid must dissolve this organic material to be an effective dust eliminator for the circuit boards 20. The indicator of the oil-dissolving capability is the aniline point. A material with a low aniline point dissolves the oils more effectively. The aniline point of volatile aromatic hydrocarbons is around 50 degrees Celsius. The aforementioned cleaning liquid has an aniline point less than 90 degrees Celsius so that it can effectively dissolve the organic material as well as the dust.

The cleaning liquid must not corrode the circuit board 20 when it is applied to the advanced electronic and communication devices for elimination of dust particles. Therefore, the aforementioned cleaning liquid must be non-corrosive.

The aforementioned cleaning liquid must not contain water because the water contained may deteriorate the insulating property of the cleaning liquid. The cleaning liquid may absorb water molecules from air when it is open to air. The water and cleaning liquid can be physically separated if the density of the cleaning liquid is sufficiently less than that of water. Therefore, the aforementioned cleaning liquid has its density less than 0.8 g/cm³ at 15 degrees Celsius. The aforementioned cleaning liquid must not contain any toxic or hazardous material to be environmentally friendly.

The method of cleaning the advanced electronic and communication devices by making use of the insulating cleaning liquid having properties mentioned above are the following.

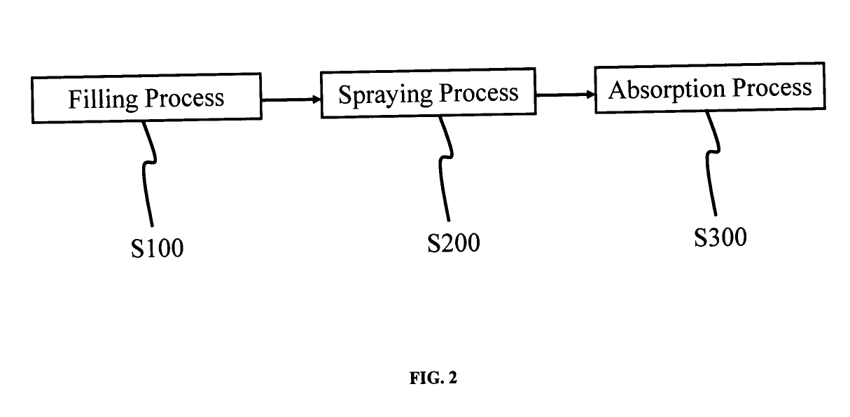

The cleaning method of circuit board 20 in the advanced electronic and communication devices is illustrated in FIGS. 1 and 2. Fill the can 10, in the filling process S100, with the specially prepared cleaning liquid and filling gas, and attach the spray device 12 to the can 10.

Spray, in the spraying process S200, the aforementioned cleaning liquid on the live circuit-board 20 in the advanced electronic and communication devices, while the power is on, by making use of the filled can 10 and the spray device 12. The spray device can either be a common spray or a jet device.

The aforementioned cleaning liquid, after being sprayed, in the adsorption process S300, mingles with accumulated dust particles on the circuit board 20, runs down the surface of the circuit board 20 and falls down from the board 20 to the adsorption pad 30 that is disposable after one time use.

The adsorption pad 30 with absorbed cleaning liquid mingles with dust particles, is discarded into a designated refuse basket. Fluorinated hydrocarbon HCFC or HFC134a can be a good candidate of filling gas for the can 10. The spraying pressure of the spray device must be higher than 5 kgf/cm² for an effective dust elimination.

### EXAMPLE 1

An example of the specially prepared cleaning liquid is ECO-SOLV which is a mixture of citrus extraction and a few hydrocarbon compounds. The physical and chemical properties of ECO-SOLV have been analyzed by the Korea Petroleum Quality Institute. The breakdown electric field of the liquid is 126.2 kV/cm. The initial boiling point and end point of ECO-SOLV for the indication of the evaporation speed are measured to be 187 degrees and 213 degrees Celsius, respectively. The surface tension and aniline point of the cleaning liquid are 24 dyne/cm² and 84 degrees Celsius, respectively. The total acid number is 0.02 mgKOH/g. According to the test, ECO-SOLV contains sulfur compound less than 1 mg/kg and is certified to be non-corrosive. The ignition point and density of the cleaning liquid are 67 degrees Celsius and 0.768 g/cm³, which is considerably lighter than water. The water containment of ECO-SOLV is 37 mg/kg, which is negligibly small. The cleaning liquid ECO-SOLV is certified to be non-toxic, but aromatic materials occupy 2.48% of the cleaning liquid volume, which consists of benzene (less than 0.01%), toluene (less than 0.01%), xylene (0.02%) and others (2.47%). This numerical data is very appropriate for the specially prepared cleaning liquid for cleaning the circuit board in the advanced electronic and communication devices. The aforementioned ECO-SOLV was filled into can 10 with filling gas of HCFC. The spray device 12 sprays ECO-SOLV over a live circuit board 20 in the advanced electronic and communication device, while the power is on. The spraying pressure of the spray device 12 was 5.2 kgf/cm². The aforementioned ECO-SOLV captured the micro dust particles on the circuit board 20, mingling with them, running down the surface of the board 20 and falling down from the board into the adsorption pad 30. Discarding the used adsorption pad 30 into the refuse basket completes a successful elimination of dust particles from the board. ECO-SOLV dissolves the organic material with dust particles accumulated on the circuit board 20 faster and more effectively, and runs down the surface of the board 20, eliminating all the dust particles deep inside any narrow gaps.

### EXAMPLE 2

The other example of the specially prepared cleaning liquid is BTS-SOLV which is a mixture of citrus extraction and a few hydrocarbon compounds. The physical and chemical properties of BTS-SOLV have been analyzed by the Korea Petroleum Quality Institute. The breakdown electric field of the liquid is 142.3 kV/cm. The initial boiling point and end point of BTS-SOLV for indication of the evaporation speed are measured to be 186 degrees and 205 degrees Celsius, respectively. The surface tension and aniline point of the cleaning liquid are 24.4 dyne/cm² and 80 degrees Celsius, respectively. The total acid number is 0.01 mgKOH/g. According to test, BTS-SOLV contains sulfur compound less than 1 mg/kg and is certified to be non-corrosive. The ignition point and density of the cleaning liquid are 66 degrees Celsius and 0.768 g/cm³, which is considerably lighter than water. The water containment of BTS-SOLV is 36 mg/kg, which is negligibly small. The cleaning liquid BTS-SOLV is certified to be non-toxic, but aromatic materials occupy 3.06% of the cleaning liquid volume, which consists of benzene (less than 0.01%), toluene (less than 0.01%), xylene (0.02%) and others (3.03%). This numerical data is very appropriate for the specially prepared cleaning liquid for cleaning the circuit board in the advanced electronic and communication devices. The aforementioned BTS-SOLV was filled into can 10 with the filling gas, HCFC. The spray device 12 sprayed BTS-SOLV over the circuit board 20 in the advanced electronic and communication device. The aforementioned BTS-SOLV captured the micro dust particles on the circuit board 20, mingling with them, running down the surface of the board 20 and falling down from the board into the adsorption pad 30. Discarding the used adsorption pad 30 into the refuse basket completes a successful elimination of dust particles from the board. BTS-SOLV dissolves the organic material with dust particles accumulated on the circuit board 20 faster and more effectively, and runs down the surface of the board 20, eliminating all the dust particles deep inside any narrow gaps.

Although this embodiment is the cleaning of circuit boards in the advanced electronic and communication devices by making use of specially prepared cleaning liquid, the invention is not limited to cleaning circuit boards. Without departing from the spirit of the invention, numerous other rearrangements, modifications and variations of the present invention are possible in light of the foregoing teachings. It is therefore to be understood that within the scope of the appended claims, the invention may be practiced otherwise than as specifically described.

What is claimed is:

1. An apparatus of cleaning the circuit boards in advanced electronic and communication devices by making use of an insulating liquid, said apparatus comprising:
(a) a can filled with specially prepared cleaning liquid and filling gas;
(b) a spray device attached to said can and capable to spray said cleaning liquid with spraying pressure of 5 kgf/cm² or more; and
(c) an adsorption pad placed under said circuit boards in advanced electronic and communication devices, adsorbing said cleaning liquid that captures the dust particles and mingles with dust, falling down from said circuit board.

2. In the apparatus according to claim 1, wherein said filling gas filled in said can is a fluorinated hydrocarbon HCFC or HFC134a.

3. In the apparatus according to claim 1, wherein said cleaning liquid is an insulating and non-corrosive liquid.

4. In the apparatus according to claim 1, wherein said cleaning liquid has the maximum breakdown field strength in the range of 100˜200 kV/cm and a total acid number of less than 0.02 mgKOH/g.

5. In the apparatus according to claim 1, wherein said cleaning liquid has the ignition point higher than 65 degrees Celsius and the aniline point less than 90 degrees Celsius.

6. In the apparatus according to claim 1, wherein said cleaning liquid has the initial boiling point in the range of 175˜195 degrees Celsius and the end point in the range of 200˜220 degrees Celsius.

7. In the apparatus according to claim 1, wherein said cleaning liquid has the surface tension less than 30 dyne/cm² and density less than 0.8 g/cm³.

8. A process for cleaning the circuit boards in advanced electronic and communication devices by making use of an insulating liquid, said process comprising:
(a) filling the specially prepared cleaning liquid and filling gas into a can and attaching the spray device to said can;
(b) spraying said cleaning liquid on the circuit boards in advanced electronic and communication devices by making use of said spraying device; and
(c) collecting dust particles accumulated on said circuit boards by said cleaning liquid and adsorbing said liquid and dust particles by adsorption pad.

9. In the process according to claim 8, wherein said cleaning liquid is an insulating and non-corrosive liquid.

10. In the process according to claim 8, wherein said cleaning liquid has the maximum breakdown field strength in the range of 100˜200 kV/cm and a total acid number of less than 0.02 mgKOH/g.

11. In the process according to claim 8, wherein said cleaning liquid has the ignition point higher than 65 degrees Celsius and the aniline point less than 90 degrees Celsius.

12. In the process according to claim 8, wherein said cleaning liquid has the initial boiling point in the range of 175˜195 degrees Celsius and the end point in the range of 200˜220 degrees Celsius.

13. In the process according to claim 8, wherein said cleaning liquid has the surface tension less than 30 dyne/cm² and density less than 0.8 g/cm³.
